(19) United States
(12) Patent Application Publication
(10) Pub. No.: US 2025/0068307 A1
(43) Pub. Date: Feb. 27, 2025

(54) OBJECT PROCESSING METHOD AND APPARATUS, ELECTRONIC DEVICE AND STORAGE MEDIUM

(71) Applicant: Beijing Zitiao Network Technology Co., Ltd., Beijing (CN)

(72) Inventors: Zhikun GAO, Beijing (CN); Lu TAO, Beijing (CN); Pei ZHOU, Beijing (CN); Kui LI, Beijing (CN)

(21) Appl. No.: 18/814,314

(22) Filed: Aug. 23, 2024

(30) Foreign Application Priority Data
Aug. 24, 2023 (CN) 202311078308.3

(51) Int. Cl. G06F 3/0484

(52) U.S. Cl. CPC G06F 3/0484

(57) ABSTRACT

Embodiments of the disclosure provides a method, an apparatus, an electronic device and a storage medium for object processing. The method includes: in response to a deletion triggering operation, obtaining a target object to be deleted; determining object attribute data and a data association relationship corresponding to the target object, where the data association relationship is a reference relationship between the target object and a superior object containing the target object; obtaining serialized object data by serializing the object attribute data, and storing the serialized object data; and dissolving the data association relationship, and deleting the target object. The technical solution of embodiments of the disclosure can truly destroy a target object, thereby avoiding target object loitering risk, releasing memory resources occupied by the target object, facilitating multiplexing of object attribute data of the target object, and providing data support for the rapid recovery of the target object.

### CROSS-REFERENCE

The present application claims priority to Chinese Patent Application No. 202311078308.3, filed on Aug. 24, 2023 and entitled “OBJECT PROCESSING METHOD AND APPARATUS, ELECTRONIC DEVICE AND STORAGE MEDIUM”, the entirety of which is incorporated herein by reference.

### FIELD

Embodiments of the present disclosure relate to computer application technologies, and in particular, to an object processing method and apparatus, an electronic device, and a storage medium.

### BACKGROUND

In editor software, undo/redo functions are very common functions, and are one of the key functions for providing user experience and operational efficiency.

Since each editing operation may relate to creation/deletion of different data objects, in order to ensure the consistency of object data under an undo/redo operation, in the related art, the object state in the undo/redo process is managed based on a closure mechanism and an object reference and other technologies, so that it is ensured that an object will not be really deleted when a deletion action occurs, so that the object implicitly survives. In addition, when an undo/restore action occurs, an association relationship between an object and data is re-established, and an object state is restored, thereby ensuring data consistency.

However, there are many problems in this object processing manner. First, since an object is not really destroyed, some binding/dependency relationships may still exist, and thus a system defect may exist. For example, the existing event monitoring still exists, and related logics are still executed after an event is triggered. Secondly, an object still exists in a memory, and the object can still be accessed by using an address of the object; therefore, an unexpected risk exists, and unnecessary memory occupation exists, resulting in the consumption of memory resources. At the same time, the complex relationship between objects and or data state also need to be specially processed again, and the undo/redo behavior for the object such as copy and paste also needs to be similarly processed, and the undo/redo logic is dispersed, complex, and redundant.

### SUMMARY

The present disclosure provide an object processing method and apparatus, an electronic device and a storage medium, so as to realize real deletion of a target object by means of deletion.

According to a first aspect, an embodiment of the present disclosure provides a method for object processing. The method includes:

in response to a deletion triggering operation, obtaining a target object to be deleted;

determining object attribute data and a data association relationship corresponding to the target object, wherein the data association relationship is a reference relationship between the target object and a superior object containing the target object;

obtaining serialized object data by serializing the object attribute data, and storing the serialized object data; and

dissolving the data association relationship, and deleting the target object.

According to a second aspect, an embodiment of the present disclosure further provides an apparatus for object processing. The apparatus includes:

a deletion triggering module configured to obtain a target object to be deleted in response to a deletion triggering operation;

a data determining module configured to determine object attribute data and a data association relationship corresponding to the target object, wherein the data association relationship is a reference relationship between the target object and a superior object containing the target object;

a serializing module configured to obtain the target object by serializing the object attribute data, and store the serialized object data; and

an object deleting module configured to dissolve the data association relationship, and delete the target object.

According to a third aspect, an embodiment of the present disclosure further provides an electronic device. The electronic device includes:

one or more processors;

a storage device for storing one or more programs,

when executed by the one or more processors, the one or more programs causes the one or more processors implement the method for processing an object according to any one of embodiments of the present disclosure.

According to a fourth aspect, an embodiment of the present disclosure further provides a storage medium including computer-executable instructions. The computer-executable instructions are configured for performing the method for processing an object according to anyone of embodiments of the present disclosure when being executed by a computer processor.

According to the technical solutions of embodiments of the present disclosure, a target object to be deleted is obtained first in response to a deletion triggering operation, so that the target object on which the deletion operation is to be executed can be accurately obtained by means of a user operation, thereby accurately matching a user requirement. Then, object attribute data and a data association relationship corresponding to a target object are determined, wherein the data association relationship is a reference relationship between the target object and a superior containing the target object, so that obtain key information about the target object is obtained. Then the object attribute data is serialized to obtain the serialized object data, and the serialized object data is stored, so as to multiplex the object attribute data when undoing the deletion. Finally, the data association relationship is dissolved, and the target object is deleted, thus the reference relationship of the object is logically processed through the system mechanism itself, ensuring that the object is really deleted, releasing memory resources occupied by the object, and ensuring the integrity of a life cycle of the object, solving the technical problems in the related art such as object loitering risk due to object's implicit survival, memory resource occupation and disperse, complexity and redundancy of logics for undo/redo, therefore, the present disclosure realizes real deletion of a target object, avoids target object loitering risk, and provides beneficial technical effects of data support for rapid recovery of the target object.

### BRIEF DESCRIPTION OF THE DRAWINGS

The above and other features, advantages, and aspects of various embodiments of the present disclosure will become more apparent with reference to the following detailed description taken in conjunction with the accompanying drawings. The same or like reference numerals represent the same or like elements throughout the drawings, it shall be understood that the drawings are illustrative and that the components and elements are not necessarily drawn to scale.

FIG. 1 is a schematic flowchart of a method for processing an object provided in an embodiment of the present disclosure;

FIG. 2 is a schematic diagram of an entity-component-system (ECS) architecture applicable to a method for processing an object provided in an embodiment of the present disclosure;

FIG. 3 is a flowchart of another method for processing an object provided in an embodiment of the present disclosure;

FIG. 4 is a structural schematic diagram of an apparatus for processing an object provided in an embodiment of the present disclosure;

FIG. 5 is a schematic structural diagram of an electronic device provided in an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to embodiments set forth herein, but rather these embodiments are provided for a thorough and complete understanding of the present disclosure. It should be understood that the drawings and embodiments of the present disclosure are only for illustrative purposes and are not intended to limit the scope of the present disclosure.

It should be understood that, the steps recorded in the method embodiments of the present disclosure may be executed in different orders, and/or executed in parallel. Furthermore, method embodiments may include additional steps and/or omit the steps illustrated. The scope of the present disclosure is not limited in this respect.

The term “including” and variations thereof as used herein refers to non-exclusive inclusion, i. e., “including but not limited to”. The term “based on” is “based at least in part on”. The term “one embodiment” means “at least one embodiment”; the term “another embodiment” means “at least one further embodiment”; and the term “some embodiments’ means “at least some embodiments”. Relevant definitions of other terms will be given in the following description.

It should be noted that, the “first”, “second”, and other concepts mentioned in the present disclosure are only used to distinguish different apparatuses, modules, or units, but are not used to limit the sequence or dependency of functions performed by these apparatuses, modules, or units.

It should be noted that the modifications of “a” and “a plurality of” mentioned in the present disclosure are illustrative rather than restrictive, and those skilled in the art should understand that they should be understood as “one or more” unless being clearly indicated otherwise.

The names of messages or information interacted between a plurality of devices in embodiments of the present disclosure are only for illustrative purposes, and are not intended to limit the scope of these messages or information.

It should be understood that, before the technical solutions disclosed in embodiments of the present disclosure are used, the user should be informed of the type of the personal information, the usage range, the usage scenario, and the like related to the present disclosure in an appropriate manner and the user's authorization shall be obtained, in accordance with relevant laws and regulations.

For example, in response to receiving an active request from a user, prompt information is sent to the user to explicitly prompt the user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the popup window may also carry a selection control for the user to select “agree” or “disagree” to provide personal information to the electronic device.

It can be understood that, the above notification and acquisition of the user authorization process are merely exemplary, and do not limit the implementation of the present disclosure, and other methods meeting relevant legal regulations may also be applied to the implementation of the present disclosure.

It is to be understood that the data involved in the technical solution (including but not limited to the data itself, the obtaining or use of the data) should comply with the requirements of the corresponding legal regulations and related provisions.

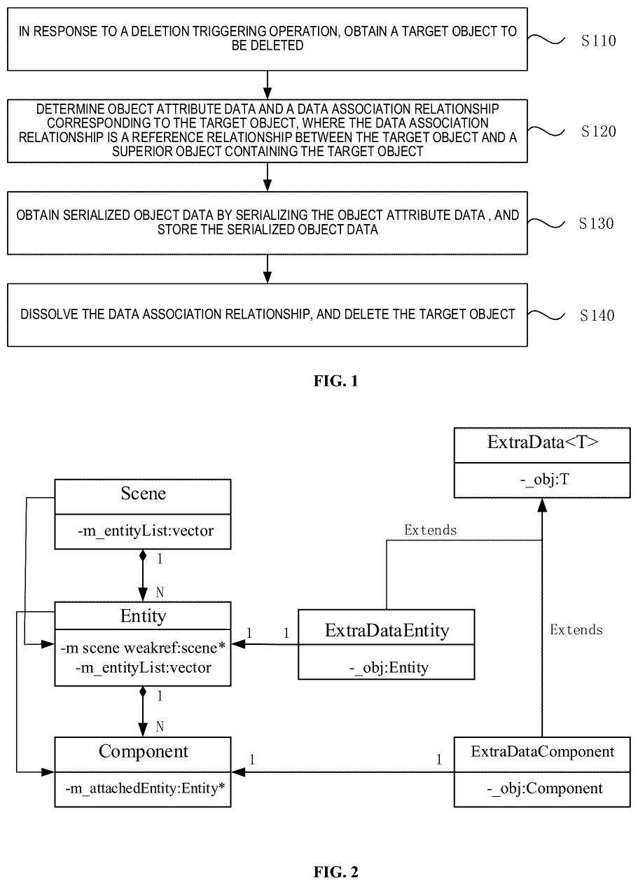

FIG. 1 is a schematic flowchart of a method for processing an object according to an embodiment of the present disclosure. The embodiment of the present disclosure is applicable to a situation in which an object is deleted and the object is restored after the object is deleted, The method may be executed by an apparatus for processing an object, and the apparatus may be implemented in the form of software and/or hardware, Optionally, the implementation is implemented by using an electronic device, where the electronic device may be a mobile terminal, a PC end, a server, or the like.

As shown in FIG. 1, the method in this embodiment may specifically include:

At S110, in response to a deletion triggering operation, a target object to be deleted is obtained.

The deletion triggering operation may be understood as an operation for performing a deletion operation on the object to be deleted after being triggered. The target object may be understood as an operation action object of a deletion triggering operation, and may also be understood as an object on which a deletion operation is to be performed. In embodiments of the present disclosure, an object is a computer language taking a computer as a carrier; the object is an abstraction of an objective, is a specific example of a class, which has a variable of a type.

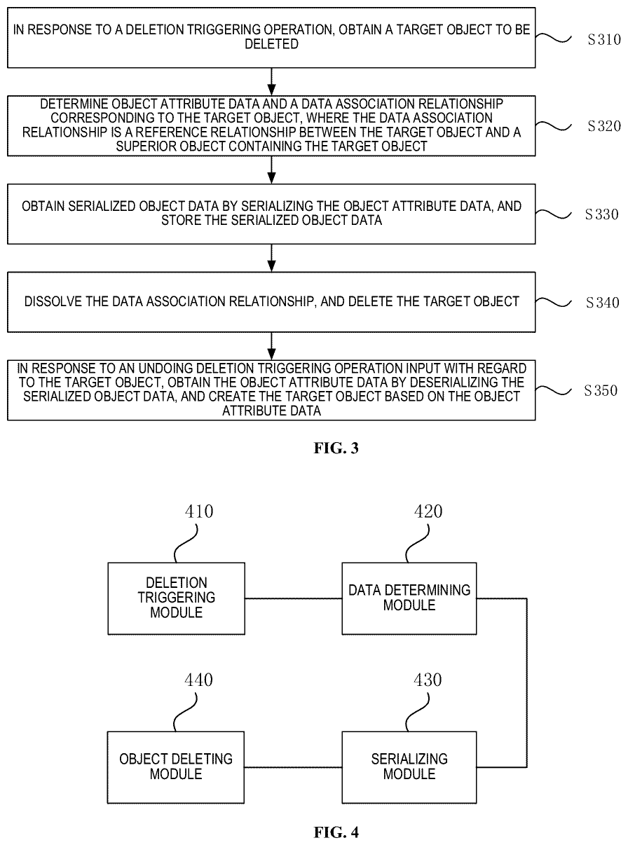

Taking the ECS architecture as an example, as shown in FIG. 2, the ECS architecture may include a scene pair Scene, an entity object Entity and a component object Component. A scene may contain a plurality of Entities and corresponding Component and System, and the contained Entities may be identified by the m_entityList attribute of Scene. Entity is a basic unit of Scene, representing an independent individual, and may be a player character, an enemy, a prop or other objects in the field of games. The Entity may contain a plurality of Component objects, and the containment relationship may be specifically represented by an m_components attribute and refers to a Scene object, and the reference relationship is represented by an m_scene_weakref attribute. An editor object corresponding to an Entity engine object is an ExtraDataEntity, which is used for managing data maintenance of the Entity in an editing state and has the Entity object. Component is one of the basic constituent parts of the Entity, which defines a special attribute, behaviour or function of the Entity, refers to the Entity object, and the reference relationship is represented by the attribute of the “m_attachedEntity” field in the Entity object. An editor object corresponding thereto is an ExtraData Component, which is used for managing data maintenance of a Component in an editing state, and has a Component object. Scene scene/entity Entity/Component, where ExtraDataEntity and ExtraDataComponent inherit from ExtraData base class, and the ExtraData defines common attribute of engine object edit state.

Alternatively, the target object may be an engine object (such as) and an editor object (such as an ExtraDataXXX object corresponding to Scene/Entity/Component) under an ECS framework.

In embodiments of the present disclosure, there may be a plurality of input manners for the deletion triggering operation. Exemplarily, the deletion triggering operation may be a control triggering operation that acts on a preset deletion control, or an action input triggering operation based on an action of collecting a preset deletion action by an image collection device, an instruction input triggering operation of collecting a pre-set voice instruction for deleting a target object based on a sound collection device, etc. The preset deletion control may be a physical control, and may also be a virtual control displayed on the interface. The control triggering operation may be a click operation, a press operation, a slide operation, or the like.

As an optional implementation of embodiments of the present disclosure, a target interface is displayed, wherein the target interface displays at least one candidate object; in response to an object selection operation input for a candidate object, a selected candidate object is determined; and in response to a deletion triggering operation, obtaining the selected candidate object as a target object to be deleted.

At S120, object attribute data and a data association relationship corresponding to a target object is determined, where the data association relationship is a reference relationship between the target object and a superior object containing the target object.

In embodiments of the present disclosure, the object attribute data may be understood attribute data for identifying a target object, which may be, for example, an object type and other attribute data except the object type. The object attribute data corresponding to different target objects is often different. It can be understood that what data is specifically included in the object attribute data can be set according to actual requirements, and the object attribute data may be data corresponding to all fields or some fields of the target object. The content of the object attribute data is not limited herein.

The superior object of the target object may be an object at a most closet level which includes the target object. Exemplarily, when the target object is a component, a superior object of the target object is an entity including the component. If the target object is an entity, a superior object thereof is a scene including the entity.

Optionally, a data association relationship corresponding to the target object is determined based on a preset field that is preset and used to indicate a superior object of the target object. For example, if the target object is a component, the preset field for indicating the superior object of the target object may be “attacheEntity” or the like.

Before deleting the target object, a judgment about the feasibility of deleting the target object can be added. Optionally, before determining the object attribute data and the data association relationship corresponding to the target object, the method further includes: determining a target execution state corresponding to a deletion triggering operation, wherein the target execution state includes an executable state and a prohibited execution state. Then, when the target execution state is the executable state, the object attribute data and the data association relationship corresponding to the target object are determined. The advantage of such setting lies in that the target object can be deleted in the case that deletion is allowed, thereby ensuring that the deletion procedure for the target object is more standard.

Optionally, determining the target execution state corresponding to the deletion triggering operation includes: determining the target execution state corresponding to the deletion triggering operation based on a preset execution check condition, and the execution check condition includes at least one of the following: whether a dependency relationship exists between the target object and another object, whether an operation object inputting the deletion triggering operation has permission for deletion operation, and whether a display area of the target object is an area opening permission for deletion operation.

Exemplarily, when the dependency relationship exists between the target object and another object, the operation object inputting the deletion triggering operation has permission for deletion operation, or the display area of the target object is an area opening permission for deletion operation, the target execution state corresponding to the deletion triggering operation is determined as the execution prohibited state. Otherwise, the target execution state corresponding to the deletion triggering operation is determined as the executable state.

Optionally, in response to that target execution state is a prohibited execution state, a prompt message is generated and presented. The prompt information may be in various forms, for example, in a voice form, a text form, an image form, or a video form. The content of the prompt information may include a reason why the target object cannot be deleted and/or result that the target object cannot be deleted. The advantage of this setting lies in that the user can be prompted that the target object cannot be deleted, which makes it convenient for the user to know the execution state of the deletion operation in time.

At S130, serialized object data is obtained by performing serialization on the object attribute data, and the serialized object data is stored.

Serialization is a process of converting object attribute data into a form that can be stored or transmitted. The serialized data is generally data having a preset data format or a preset data structure, and exemplarily, the serialized data may be Json data, binary data, or the like.

Optionally, a predefined object serialization interface corresponding to the target object is called to serialize the object attribute data of the target object to obtain serialized object data. The advantages of such a setting lie in that the normalization conversion of object attribute data can be realized, and the data format or data structure of the serialized object data is relatively unified, thereby facilitating storage; furthermore, compared with storing the object attribute data, storing the serialized object data occupies less storage space, thereby reducing memory occupation.

During serialization, an object writes its current state to a temporary or persistent storage area. Thereafter, the object may be recreated by reading the object's state from the storage area or deserializing the object's state. In embodiments of the present disclosure, the serialized object data may be stored based on a preset storage path. The preset storage path may be a storage path preset according to practical requirements and corresponding to the serialization data of the target object. The specific storage location is not limited herein. It can be understood that the serialized object data is stored in association with the target object, for example, the serialized object data of the target object may be associated through the object identifier of the target object, and so on.

At S140, the data association relationship is dissolved, and the target object is deleted.

Specifically, dissolving the data association relationship may include: determining a superior object containing the target object, and deleting a record corresponding to the target object from a reference relationship list recording the superior object.

The reference relationship list is an object list in which all subordinate objects contained in the superior object are recorded.

Alternatively, determining a superior object including a target object includes: searching, in an association field of the target object, for a preset field used for indicating the superior object of the target object; and based on a parameter value corresponding to the preset field, determining the superior object including the target object.

Optionally, before deleting, from the reference relationship list in which the superior object is recorded, the record corresponding to the target object, the method further includes: querying, in an association field of the superior object, a preset identification field corresponding to the reference relationship list, so as to obtain based on a parameter corresponding to the identification field, the reference relationship list in which the superior object is recorded. For example, when the superior object is an entity, the identification field corresponding to the reference relationship list may be “entitylist”, or the like.

After the reference relationship list in which the superior object is recorded is obtained, the record corresponding to the target object is deleted from the reference relationship list, thereby dissolving the data association relationship corresponding to the target object.

As described above, the target object may include an engine object and an editor object. Specifically, deleting the target object may include deleting the engine object and the editor object corresponding to the target object when the target object is a component. In other words, when a Component is deleted, the reference relationship of the Entity is dissolved, and at the same time the corresponding ExtraData Component object is deleted. The advantage of this setting lies in that a component object can be deleted quickly and thoroughly, thereby avoiding component object loitering risk, and releasing the memory resource occupied by the component.

Optionally, in the case where the target object is an entity, deleting the target object includes: determining, based on a data structure of the target object, a sub-object to be deleted in the target object, wherein the sub-object to be deleted comprises at least one sub-entity and/or component mounted under the entity, and the sub-entity comprises a component mounted under the sub-entity; taking a last level of the sub-objects to be deleted as a start point, deleting, one by one, engine objects and editor objects corresponding to the sub-objects to be deleted in a depth-first traversal manner. Similarly, when the Entity is deleted, the reference relationship of Scene is dissolved and the attached Component is deleted, while the corresponding ExtraXXX object is deleted. The advantages of such a setting lie in that, an entity object can be parsed on the basis of a data structure of the entity object; and step by step deletion is performed hierarchically, thus thorough deletion of the entity object is realized; entity object loitering risk is avoided, memory resources occupied by the entity object are released, and it can be ensured that a deletion process of the entity object proceeds smoothly.

According to the technical solutions of embodiments of the present disclosure, a target object to be deleted is obtained first in response to a deletion triggering operation, so that the target object on which the deletion operation is to be executed can be accurately obtained by means of a user operation, thereby accurately matching a user requirement. Then, object attribute data and a data association relationship corresponding to a target object are determined, wherein the data association relationship is a reference relationship between the target object and a superior containing the target object, so that obtain key information about the target object is obtained. Then the object attribute data is serialized to obtain the serialized object data, and the serialized object data is stored, so as to multiplex the object attribute data when undoing the deletion. Finally, the data association relationship is dissolved, and the target object is deleted, thus the reference relationship of the object is logically processed through the system mechanism itself, ensuring the object is really deleted, releasing memory resources occupied by the object, and ensuring the integrity of a life cycle of the object, solving the technical problems in the related art such as object loitering risk due to object's implicit survival, memory resource occupation and disperse, complexity and redundancy of logics for undo/redo, therefore, the present disclosure realizes real deletion of a target object, avoids the target object loitering risk, and provides beneficial technical effects of data support for rapid recovery of the target object.

FIG. 3 is a schematic flowchart of another method for processing an object according to an embodiment of the present disclosure. Based on the foregoing embodiments, the technical solution of this embodiment further details the method for restoring a deleted target object. Optionally, after deleting the target object, the method further includes: in response to an undoing deletion triggering operation input with regard to the target object, deserializing the serialized object data to obtain the object attribute data, and creating the target object based on the object attribute data. For specific implementations, reference may be made to the description of this embodiment, and the technical features that are the same as or similar to those in the foregoing embodiment are not repeated herein.

As shown in FIG. 3, the method in this embodiment may specifically include:

At S310, in response to a deletion triggering operation, a target object to be deleted is obtain.

At S320, object attribute data and a data association relationship corresponding to the target object are determined, wherein the data association relationship is a reference relationship between the target object and a superior object containing the target object.

At S330, serialized object data is obtained by serializing the object attribute data, and the serialized object data is stored.

At S340, the data association relationship is dissolved, and the target object is deleted.

At S350, in response to an undoing deletion triggering operation input with regard to the target object, the object attribute data is obtained by deserializing the serialized object data, and the target object is created based on the object attribute data.

The undoing deletion triggering operation may be understood as an operation for restoring a deleted target object after being triggered. Similarly, there may be a plurality of input manners for the undoing deletion triggering operation. Exemplarily, the deletion triggering operation may be a control triggering operation that acts on a preset undoing deletion control, or an action input triggering operation based on a preset undoing deletion action collected by an image collection device, or, an instruction input triggering operation based on a preset instruction input triggering operation collected by a sound collection device and configured to withdraw a voice instruction for deleting a target object, etc. The undoing deletion control may be a physical control, and may also be a virtual control displayed on the interface. The control triggering operation may be a click operation, a press operation, a slide operation, or the like.

In embodiments of the present disclosure, a predefined deserialization interface corresponding to the target object may be called to deserialize the serialized object data to obtain the object attribute data.

As stated previously, the object attribute data may include object type data and other attribute data. Specifically, creating the target object based on the object attribute data may include: creating, based on the object type data, an initial object corresponding to the target object, wherein attribute data in the initial object is default attribute data; determining a superior object corresponding to the initial object, and establishing a data association relationship between the initial object and the superior object; and updating the default attribute data in the initial object based on the other attribute data to obtain the target object.

It can be understood that initial objects corresponding to target objects of different object types are generally different. The initial object may be understood as an object generated based on a generic field of an object of the object type.

The superior object corresponding to the initial object is the superior object corresponding to the target object. Specifically, the superior object corresponding to the initial object may be determined based on data in the object attribute data that is used to indicate the superior object corresponding to the target object.

Establishing a data association relationship between an initial object and a superior object may be adding a record corresponding to the initial object to a reference relationship list of the superior object.

Updating default attribute data in an initial object based on other attribute data may specifically be copying other attribute data to the initial object so as to cover or replace the default attribute data in the initial object, thereby obtaining a target object.

As described above, the entity may include a sub-entity and/or component. The sub-entity may further include a sub-entity and/or component of a lower level corresponding to the sub-entity; the manner for creating the target object based on the object attribute data may be: creating the target object level by level based on the object attribute data in a breadth-first traversal manner. Specifically, if the target object is an entity, by taking a first-level of sub-object (root node) to be created of the entity as a start point, an engine object and an editor object corresponding to the sub-object to be created are created level by level by using a breadth-first traversal manner. The sub-object to be created may be understood as a sub-entity and/or component included in the entity.

According to the technical solutions of embodiments of the present disclosure, by deserializing serialized object data to obtain object attribute data, key data of a target object can be obtained, and a target object is created based on the object attribute data, an association relationship between the object and the data is reestablished, and the object state is restored. Thus, the data consistency is ensured, the target object can be restored simply and quickly, and the use experience of object processing is improved.

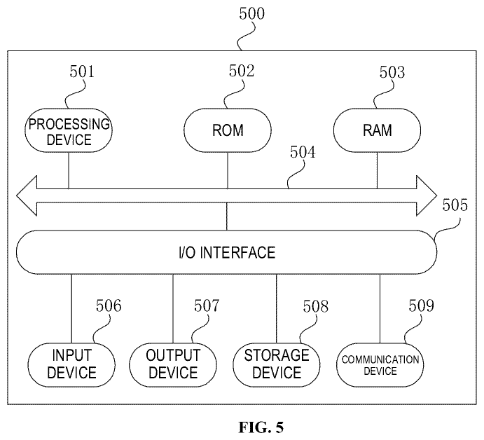

FIG. 4 is a schematic structural diagram of an apparatus for processing an object according to an embodiment of the present disclosure. As shown in FIG. 4, the apparatus for processing an object includes: a deletion triggering module 410, a data determining module 420, a serializing module 430, and an object deleting module 440.

The deletion triggering module 410 is configured to obtain a target object to be deleted in response to a deletion triggering operation; a data determining module 420 is configured to determine object attribute data and a data association relationship corresponding to the target object, wherein the data association relationship is a reference relationship between the target object and a superior object containing the target object; and a serializing module 430 is configured to obtain the target object by serializing the object attribute data, and store the serialized object data; the object deleting module 440 is configured to dissolve the data association relationship, and delete the target object.

According to the technical solutions of embodiments of the present disclosure, firstly, in response to a deletion triggering operation, a deletion triggering module obtain a target object to be deleted, so that the target object on which the deletion operation is to be executed can be accurately obtained by means of a user operation, thereby accurately matching a user requirement. Then, object attribute data and a data association relationship corresponding to a target object are determined by a data determining module, where the data association relationship is a reference relationship between the target object and a superior containing the target object, so as to obtain key information about the target object. Then, the object attribute data is serialized via the serialization module to obtain the serialized object data, and the serialized object data is stored, so as to multiplex the object attribute data when undoing the deletion. Finally, the object deletion module dissolves the data association relationship, deletes the target object, and logically processes the reference relationship of the object based on the system mechanism itself, ensuring that the object is really deleted, releasing memory resources occupied by the object, and ensuring the integrity of a life cycle of the object, solving the technical problems in the related art such as object loitering risk due to object's implicit survival, memory resource occupation and disperse, complexity and redundancy of logics for undo/redo, therefore, the present disclosure realizes real deletion of a target object, avoids target object loitering risk, and provides beneficial technical effects of data support for rapid recovery of the target object.

On the basis of the foregoing optional technical solutions, optionally, the object deleting module 440 is specifically configured to:

determine a superior object containing the target object, and delete a record corresponding to the target object from a reference relationship list recording the superior object, wherein the reference relationship list is an object list recording all subordinate objects contained in the superior object.

On the basis of the foregoing optional technical solutions, optionally, the object deleting module 440 is specifically configured to:

in response to the target object being a component, delete an engine object and an editor object corresponding to the target object.

On the basis of the foregoing optional technical solutions, optionally, the object deleting module 440 is specifically configured to:

in response to the target object being an entity, determine, based on a data structure of the target object, a sub-object to be deleted in the target object, wherein the sub-object to be deleted comprises at least one sub-entity and/or component mounted under the entity, and the sub-entity comprises a component mounted under the sub-entity; and

with a last level of the sub-objects to be deleted as a start point, delete, one by one, engine objects and editor objects corresponding to the sub-objects to be deleted in a depth-first traversal manner.

On the basis of the foregoing optional technical solutions, optionally, the apparatus for processing an object further includes:

a cancellation triggering module, configured to, after the target object is cancelled, in response to a undoing deletion triggering operation input with respect to the target object, obtain the object attribute data by deserializing the serialized object data; and

an object creating module configured to create the target object based on the object attribute data.

On the basis of the foregoing optional technical solutions, optionally, the object attribute data includes object type data and other attribute data. Accordingly, the object creating module includes an initial object creating unit, a data association establishing unit and a target object generating unit.

The initial object creating unit is configured to create, based on the object type data, an initial object corresponding to the target object, wherein attribute data in the initial object is default attribute data; the data association establishing unit is configured to determine a superior object corresponding to the initial object, and establish a data association relationship between the initial object and the superior object; and the target object generating unit is configured to obtain the target object by updating the default attribute data in the initial object based on the other attribute data.

On the basis of the foregoing optional technical solutions, optionally, the data determining module 420 includes: an execution state determining unit and an object data obtaining unit.

The execution state determining unit is configured to a target execution state corresponding to the deletion triggering operation, wherein the target execution state comprises an executable state and a prohibited execution state; and the object data obtaining unit is configured to determine, in response to the target execution state being the executable state, the object attribute data and the data association relation corresponding to the target object.

On the basis of the foregoing optional technical solutions, optionally, the execution state determining unit is specifically configured to:

determine the target execution state corresponding to the deletion triggering operation based on a preset execution check condition, wherein the execution check condition includes at least one of the following: whether a dependency relationship exists between the target object and another object, whether an operation object inputting the deletion triggering operation has permission for deletion operation, and whether a display area of the target object is an area opening permission for deletion operation.

The apparatus for processing an object provided in the embodiment of the present disclosure can execute the method for processing an object provided in any embodiment of the present disclosure, and has corresponding functional modules for executing the method and beneficial effects.

It should be noted that, the units and modules included in the foregoing apparatus are divided only according to functional logic, but are not limited to the foregoing division, as long as corresponding functions can be implemented. In addition, specific names of various functional units are only intended to distinguish from each other, but are not intended to limit the scope of protection of embodiments of the present disclosure.

FIG. 5 is a structural schematic diagram of an electronic device provided in an embodiment of the present disclosure. Referring to FIG. 5 below, it is a structural schematic diagram of an electronic device (such as the terminal device or server in FIG. 5) suitable for implementing the embodiment of the present disclosure. The terminal device 500 in the embodiment of the present disclosure may include but is not limited to mobile terminals such as mobile phones, laptops, digital broadcast receivers, PDAs (Personal Digital Assistants), PADs (tablet computers), PMPs (portable multimedia players), car-mounted terminals (such as car navigation terminals), etc. and fixed terminals such as digital televisions (TV), desktop computers, etc. The electronic device shown in FIG. 5 is only an example and should not bring any limitation on the functionality and scope of use of the embodiment of the present disclosure.

As shown in FIG. 5, the electronic device 500 may include a processing device (such as a central processing unit, graphics processing unit, etc.) 501, which may perform various appropriate actions and processes based on programs stored in Read-Only Memory (ROM) 502 or loaded from storage device 508 into Random Access Memory (RAM) 503. In the RAM 503, various programs and data necessary for the operation of the electronic device 500 are also stored. The processing device 501, ROM 502, and RAM 503 are connected to each other through a bus 504. An Input/Output I/O interface 505 is also connected to the bus 504.

Typically, the following devices can be connected to I/O interface 505: input devices 506 including, for example, touch screens, touchpads, keyboards, mice, cameras, microphones, accelerometers, gyroscopes, etc.; output devices 507 including liquid crystal displays (LCDs), speakers, vibrators, etc.; storage devices 508 including magnetic tapes, hard disks, etc.; and a communication device 509. The communication device 509 may allow the electronic device 500 to communicate with other devices wirelessly or wirelessly to exchange data. Although FIG. 5 shows an electronic device 500 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 509, or installed from the storage device 508, or installed from the ROM 502. When the computer program is executed by the processing device 501, the above functions defined in the method of the embodiment of the present disclosure are performed.

The names of the messages or information exchanged between a plurality of devices in the embodiment of the present disclosure are for illustrative purposes only and are not intended to limit the scope of these messages or information.

The electronic device provided in this embodiment of the present disclosure and the method for processing an object provided in the above embodiments belongs to the invention idea. Technical details that are not described in detail in this embodiment can be found in the above embodiments, and this embodiment has the same beneficial effect as the above embodiments.

An embodiment of the present disclosure provides a computer storage medium on which a computer program is stored, when being executed by a processor, the program implements the method for processing an object provided in the above embodiments.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

In some embodiments, clients and servers can communicate using any currently known or future developed network protocol such as HTTP (HyperText Transfer Protocol), and can be interconnected with any form or medium of digital data communication (such as communication networks). Examples of communication networks include local area networks (“LANs”), wide area networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device: in response to a deletion triggering operation, obtain a target object to be deleted; determine object attribute data and a data association relationship corresponding to the target object, wherein the data association relationship is a reference relationship between the target object and a superior object containing the target object; serialize the object attribute data to obtain serialized object data, and store the serialized object data; and dissolve the data association relationship, and delete the target object.

Computer program codes for performing the operations of the present disclosure may be written in one or more programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, Example 1 provides an object processing method, including:

in response to a deletion triggering operation, obtaining a target object to be deleted;

determining object attribute data and a data association relationship corresponding to the target object, wherein the data association relationship is a reference relationship between the target object and a superior object containing the target object;

obtaining serialized object data by serializing the object attribute data, and storing the serialized object data; and

dissolving the data association relationship, and deleting the target object.

According to one or more embodiments of the present disclosure, Example 2 provides a method according to Example 1, further including:

optionally, dissolving the data association relationship may include that:

determining a superior object containing the target object, and deleting a record corresponding to the target object from a reference relationship list recording the superior object, where the reference relationship list is an object list recording all subordinate objects contained in the superior object.

According to one or more embodiments of the present disclosure, Example 3 provides a method according to Example 1, further including:

optionally, deleting the target object includes:

in response to the target object being a component, deleting an engine object and an editor object corresponding to the target object.

According to one or more embodiments of the present disclosure, Example 4 provides a method according to Example 1, further including:

optionally, deleting the target object includes:

in response to the target object being an entity, determining, based on a data structure of the target object, a sub-object to be deleted in the target object, wherein the sub-object to be deleted comprises at least one sub-entity and/or component mounted under the entity, and the sub-entity comprises a component mounted under the sub-entity; and

with a last level of the sub-objects to be deleted as a start point, deleting, one by one, engine objects and editor objects corresponding to the sub-objects to be deleted in a depth-first traversal manner.

According to one or more embodiments of the present disclosure, Example 5 provides a method according to Example 1, further including:

optionally, after deleting the target object, the method further includes:

in response to an undoing deletion triggering operation input with regard to the target object, obtaining the objecting attribute data by deserializing the serialized object data, and creating the target object based on the object attribute data.

According to one or more embodiments of the present disclosure, Example 6 provides a method according to Example 5, further including:

optionally, the object attribute data includes object type data and other attribute data;

creating the target object based on the object attribute data including:

creating, based on the object type data, an initial object corresponding to the target object, wherein attribute data in the initial object is default attribute data;

determining a superior object corresponding to the initial object, and establishing a data association relationship between the initial object and the superior object; and

obtaining the target object by updating the default attribute data in the initial object based on the other attribute data.

According to one or more embodiments of the present disclosure, Example 7 provides a method according to Example 1, further including:

optionally, determining the object attribute data and the data association relationship corresponding to the target object includes:

determining a target execution state corresponding to the deletion triggering operation, wherein the target execution state comprises an executable state and a prohibited execution state; and

in response to the target execution state being the executable state, determining the object attribute data and the data association relation corresponding to the target object.

According to one or more embodiments of the present disclosure, Example 8 provides a method according to Example 7, further including:

optionally, determining the target execution state corresponding to the delete triggering operation includes:

determining the target execution state corresponding to the deletion triggering operation based on a preset execution check condition, wherein the execution check condition includes at least one of the following: whether a dependency relationship exists between the target object and another object, whether an operation object inputting the deletion triggering operation has permission for deletion operation, or whether a display area of the target object is an area opening permission for deletion operation.

According to one or more embodiments of the present disclosure, Example 9 provides an apparatus for processing an object, including:

a deletion triggering module configured to obtain a target object to be deleted in response to a deletion triggering operation;

a data determining module configured to determine object attribute data and a data association relationship corresponding to the target object, wherein the data association relationship is a reference relationship between the target object and a superior object containing the target object;

a serializing module configured to obtain serialized object data by serializing the object attribute data, and store the serialized object data; and

an object deleting module configured to dissolve the data association relationship, and delete the target object.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

What is claimed is:

1. A method for object processing, comprising:
in response to a deletion triggering operation, obtaining a target object to be deleted;
determining object attribute data and a data association relationship corresponding to the target object, wherein the data association relationship is a reference relationship between the target object and a superior object containing the target object;
obtaining serialized object data by serializing the object attribute data, and storing the serialized object data; and
dissolving the data association relationship, and deleting the target object.

2. The method for object processing of claim 1, wherein dissolving the data association relationship comprises:
determining the superior object containing the target object, and deleting a record corresponding to the target object from a reference relationship list recording the superior object, wherein the reference relationship list is an object list recording all subordinate objects contained in the superior object.

3. The method for object processing of claim 1, wherein deleting the target object comprises:
in response to the target object being a component, deleting an engine object and an editor object corresponding to the target object.

4. The method for object processing of claim 1, wherein deleting the target object comprises:
in response to the target object being an entity, determining, based on a data structure of the target object, a sub-object to be deleted in the target object, wherein the sub-object to be deleted comprises at least one sub-entity and/or component mounted under the entity, and the sub-entity comprises a component mounted under the sub-entity; and
with a last level of the sub-object to be deleted as a start point, deleting, one by one, engine objects and editor objects corresponding to the sub-object to be deleted in a depth-first traversal manner.

5. The method for object processing of claim 1, further comprising:
after deleting the target object,
in response to an undoing deletion triggering operation input with regard to the target object, obtaining the object attribute data by deserializing the serialized object data, and creating the target object based on the object attribute data.

6. The method for object processing of claim 5, wherein the object attribute data comprises object type data and other attribute data;
wherein creating the target object based on the object attribute data comprises:
creating, based on the object type data, an initial object corresponding to the target object, wherein attribute data in the initial object is default attribute data;
determining a superior object corresponding to the initial object, and establishing a data association relationship between the initial object and the superior object; and
obtaining the target object by updating the default attribute data in the initial object based on the other attribute data.

7. The method for object processing of claim 1, wherein determining the object attribute data and the data association relationship corresponding to the target object comprises:
determining a target execution state corresponding to the deletion triggering operation, wherein the target execution state comprises an executable state and a prohibited execution state; and
in response to the target execution state being the executable state, determining the object attribute data and the data association relationship corresponding to the target object.

8. The method for object processing of claim 7, wherein determining the target execution state corresponding to the delete triggering operation comprises:
determining the target execution state corresponding to the deletion triggering operation based on a preset execution check condition, wherein the execution check condition comprises at least one of the following: whether a dependency relationship exists between the target object and another object, whether an operation object inputting the deletion triggering operation has permission for deletion operation, or whether a display area of the target object is an area opening permission for deletion operation.

9. An electronic device, comprising:
one or more processors;
a storage device for storing one or more programs; and
wherein the one or more programs, when executed by the one or more processors, cause the one or more processors to perform acts comprising:
in response to a deletion triggering operation, obtaining a target object to be deleted;
determining object attribute data and a data association relationship corresponding to the target object, wherein the data association relationship is a reference relationship between the target object and a superior object containing the target object;
obtaining serialized object data by serializing the object attribute data, and storing the serialized object data; and
dissolving the data association relationship, and deleting the target object.

10. The electronic device of claim 9, wherein dissolving the data association relationship comprises:
determining the superior object containing the target object, and deleting a record corresponding to the target object from a reference relationship list recording the superior object, wherein the reference relationship list is an object list recording all subordinate objects contained in the superior object.

11. The electronic device of claim 9, wherein deleting the target object comprises:
in response to the target object being a component, deleting an engine object and an editor object corresponding to the target object.

12. The electronic device of claim 9, wherein deleting the target object comprises:
in response to the target object being an entity, determining, based on a data structure of the target object, a sub-object to be deleted in the target object, wherein the sub-object to be deleted comprises at least one sub-entity and/or component mounted under the entity, and the sub-entity comprises a component mounted under the sub-entity; and
with a last level of the sub-object to be deleted as a start point, deleting, one by one, engine objects and editor objects corresponding to the sub-object to be deleted in a depth-first traversal manner.

13. The electronic device of claim 9, wherein the acts further comprises:
after deleting the target object,
in response to an undoing deletion triggering operation input with regard to the target object, obtaining the object attribute data by deserializing the serialized object data, and creating the target object based on the object attribute data.

14. The electronic device of claim 13, wherein the object attribute data comprises object type data and other attribute data;
wherein creating the target object based on the object attribute data comprises:
creating, based on the object type data, an initial object corresponding to the target object, wherein attribute data in the initial object is default attribute data;
determining a superior object corresponding to the initial object, and establishing a data association relationship between the initial object and the superior object; and
obtaining the target object by updating the default attribute data in the initial object based on the other attribute data.

15. The electronic device of claim 9, wherein determining the object attribute data and the data association relationship corresponding to the target object comprises:
determining a target execution state corresponding to the deletion triggering operation, wherein the target execution state comprises an executable state and a prohibited execution state; and
in response to the target execution state being the executable state, determining the object attribute data and the data association relationship corresponding to the target object.

16. The electronic device of claim 15, wherein determining the target execution state corresponding to the delete triggering operation comprises:
determining the target execution state corresponding to the deletion triggering operation based on a preset execution check condition, wherein the execution check condition comprises at least one of the following: whether a dependency relationship exists between the target object and another object, whether an operation object inputting the deletion triggering operation has permission for deletion operation, or whether a display area of the target object is an area opening permission for deletion operation.

17. A non-transitory storage medium comprising computer-executable instructions, wherein the computer-executable instructions, when executed by a computer processor, performs a method comprising:
in response to a deletion triggering operation, obtaining a target object to be deleted;
determining object attribute data and a data association relationship corresponding to the target object, wherein the data association relationship is a reference relationship between the target object and a superior object containing the target object;
obtaining serialized object data by serializing the object attribute data, and storing the serialized object data; and
dissolving the data association relationship, and deleting the target object.

18. The non-transitory storage medium of claim 17, wherein dissolving the data association relationship comprises:
determining the superior object containing the target object, and deleting a record corresponding to the target object from a reference relationship list recording the superior object, wherein the reference relationship list is an object list recording all subordinate objects contained in the superior object.

19. The non-transitory storage medium of claim 17, wherein deleting the target object comprises:
in response to the target object being a component, deleting an engine object and an editor object corresponding to the target object.

20. The non-transitory storage medium of claim 17, wherein deleting the target object comprises:
in response to the target object being an entity, determining, based on a data structure of the target object, a sub-object to be deleted in the target object, wherein the sub-object to be deleted comprises at least one sub-entity and/or component mounted under the entity, and the sub-entity comprises a component mounted under the sub-entity; and
with a last level of the sub-object to be deleted as a start point, deleting, one by one, engine objects and editor objects corresponding to the sub-object to be deleted in a depth-first traversal manner.
